(19) United States
(12) Patent Application Publication
(10) Pub. No.: US 2015/0158556 A1
(43) Pub. Date: Jun. 11, 2015

(54) FOUL RELEASE MATERIAL FOR USE WITH FAIRINGS

(71) Applicant: WESTERNGECO L.L.C., Houston, TX (US)

(72) Inventors: Joel Pederick, Asker (NO); Anders Nesheim, Asker (NO); Charles Thomas, Vanderpool, TX (US); Robert Frank Applegate, Sugar Land, TX (US)

(21) Appl. No.: 14/562,864

(22) Filed: Dec. 8, 2014

Related U.S. Application Data
(60) Provisional application No. 61/913,413, filed on Dec. 9, 2013.

(51) Int. Cl. B63B 21/66; G01V 1/38

(52) U.S. Cl. CPC B63B 21/663; G01V 1/38

(57) ABSTRACT

Various implementations directed to a foul release material for use with fairings. In one implementation, a seismic cable for use in a seismic acquisition system may include a fairing configured to engage with an outer diameter of the seismic cable. The seismic cable may also include a foul release material applied to an outer surface of the fairing, where the foul release material is configured to minimize the formation of biofouling on the outer surface of the fairing.

### CROSS-REFERENCE TO RELATED APPLICATIONS

This application claims benefit of U.S. provisional patent application Ser. No. 61/913,413, filed Dec. 9, 2013 and titled FOUL RELEASE MARINE SEISMIC FAIRING, the entire disclosure of which is herein incorporated by reference.

### BACKGROUND

In a seismic survey, a plurality of seismic sources, such as explosives, vibrators, airguns or the like, may be sequentially activated near the surface of the earth to generate energy (i.e., seismic waves) which may propagate into and through the earth. The seismic waves may be reflected back by geological formations within the earth, and the resultant seismic wavefield may be sampled by a plurality of seismic receivers, such as geophones, hydrophones and the like. Each receiver may be configured to acquire seismic data at the receiver's location, normally in the form of a seismogram representing the value of some characteristic of the seismic wavefield against time. The acquired seismograms or seismic data may be transmitted wirelessly or over electrical or optical cables to a recorder system. The recorder system may then store, analyze, and/or transmit the seismic data. This data may be used to generate an image of subsurface formations in the earth and may also be used to detect the possible presence of hydrocarbons, changes in the subsurface formations and the like.

For example, in a marine seismic survey, an array of seismic streamers having hydrophones may be towed behind a seismic survey vessel. One or more of the streamers may be towed using various cables, such as lead-in cables. In such an example, one or more fairings may also be used to reduce drag produced by the towing of the streamers and/or various cables.

### SUMMARY

Described herein are implementations of various technologies and techniques for a foul release material for use with fairings. In one implementation, a seismic cable for use in a seismic acquisition system may include a fairing configured to engage with an outer diameter of the seismic cable. The seismic cable may also include a foul release material applied to an outer surface of the fairing, where the foul release material is configured to minimize the formation of biofouling on the outer surface of the fairing.

In another implementation, a seismic acquisition system may include a vessel and may include a seismic cable coupled to a seismic streamer, where the seismic cable is configured to be towed by the vessel. The seismic cable may include a fairing configured to engage with an outer diameter of the respective seismic cable. The seismic cable may also include a foul release material applied to an outer surface of the fairing, where the foul release material is configured to minimize the formation of biofouling on the outer surface of the fairing.

In yet another implementation, a method may include applying a foul release material to an outer surface of a fairing, where the foul release material is configured to minimize the formation of biofouling on the outer surface of the fairing. The method may also include attaching the fairing to an outer diameter of a seismic cable for use in a seismic acquisition system.

The above referenced summary section is provided to introduce a selection of concepts in a simplified form that are further described below in the detailed description section. The summary is not intended to be used to limit the scope of the claimed subject matter. Furthermore, the claimed subject matter is not limited to implementations that solve any disadvantages noted in any part of this disclosure. Indeed, the systems, methods, processing procedures, techniques, and workflows disclosed herein may complement or replace conventional methods for identifying, isolating, and/or processing various aspects of seismic signals or other data that is collected from a subsurface region or other multi-dimensional space, including time-lapse seismic data collected in a plurality of surveys.

### BRIEF DESCRIPTION OF THE DRAWINGS

Implementations of various techniques will hereafter be described with reference to the accompanying drawings. It should be understood, however, that the accompanying drawings illustrate the various implementations described herein and are not meant to limit the scope of various techniques described herein.

FIG. 1 illustrates a schematic diagram of a marine-based seismic acquisition system in accordance with implementations of various techniques described herein.

FIGS. 2 and 3 illustrate a cross-sectional view and a perspective view, respectively, of a fabric fairing in accordance with implementations of various techniques described herein.

### DETAILED DESCRIPTION

The discussion below is directed to certain specific implementations. It is to be understood that the discussion below is for the purpose of enabling a person with ordinary skill in the art to make and use any subject matter defined now or later by the patent “claims” found in any issued patent herein.

It is specifically intended that the claims not be limited to the implementations and illustrations contained herein, but include modified forms of those implementations including portions of the implementations and combinations of elements of different implementations as come within the scope of the following claims.

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to obscure aspects of the embodiments.

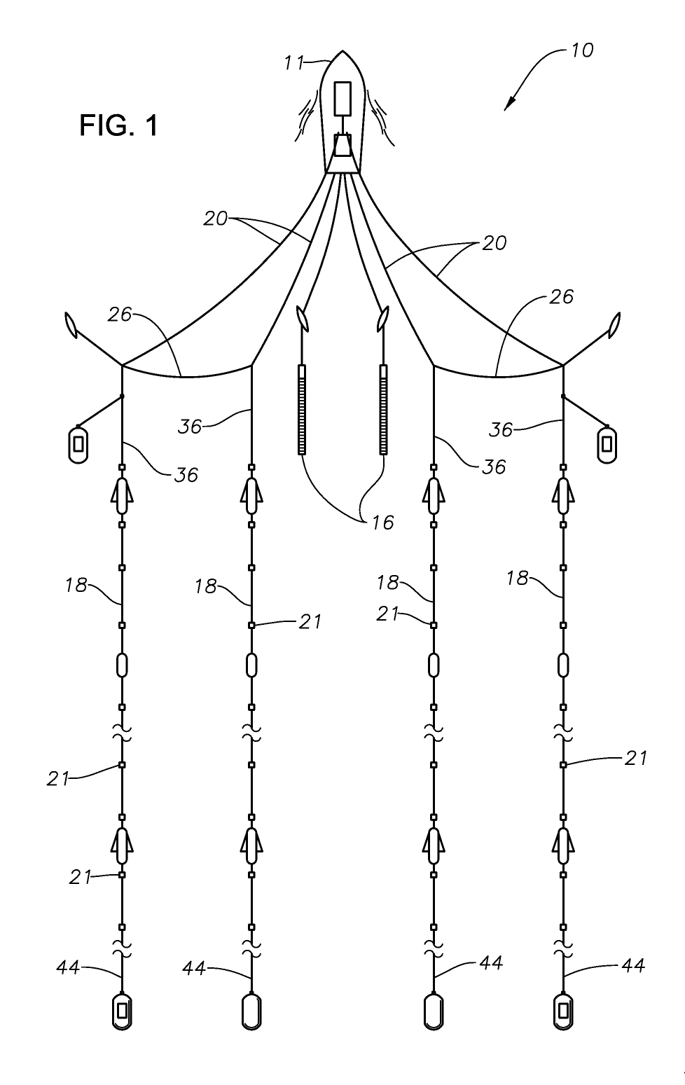

One or more implementations of various techniques for a foul release material for use with fairings will now be described in more detail with reference to FIGS. 1-3 in the following paragraphs.

### Seismic Acquisition

### System

Seismic exploration may involve surveying subterranean geological formations for hydrocarbon deposits. A seismic survey may involve deploying seismic equipment, such as seismic source(s) and seismic receivers, at predetermined locations in one or more various configurations, as further explained below.

For example, FIG. 1 illustrates a schematic diagram of a marine-based seismic acquisition system 10 in accordance with implementations of various techniques described herein. In system 10, survey vessel 11 tows one or more seismic streamers 18 behind the vessel 11. In one implementation, streamers 18 may be arranged in a spread in which multiple streamers 18 are towed in approximately the same plane at the same depth. Although various techniques are described herein with reference to a marine-based seismic acquisition system shown in FIG. 1, it should be understood that other marine-based seismic acquisition system configurations may also be used. For instance, the streamers may be towed at multiple planes and/or multiple depths, such as in an over/under configuration. In one implementation, the streamers may be towed in a slanted configuration, where fronts of the streamers are towed shallower than tail ends of the streamers.

Seismic streamers 18 may be several thousand meters long and may be used in conjunction with various seismic cables. Wiring and/or circuitry may be used to facilitate communication along the streamers 18. Each streamer 18 may include a primary cable where seismic receivers 21 that record seismic signals may be mounted. Depending on the particular survey need, the seismic receivers 21 may include one or more hydrophones, geophones, particle displacement sensors, particle velocity sensors, accelerometers, pressure gradient sensors, or combinations thereof. In one implementation, the seismic receiver 21 may be implemented as a single device or may be implemented as a plurality of devices.

The various seismic cables used with the seismic streamers 18 may include one or more lead-ins 20. In particular, the lead-ins 20 may be used to tow the streamers 18, and may be high strength steel or fiber-reinforced cables which convey electrical power, control, and/or data signals between the vessel 11 and the streamers 18. The seismic cables may also include one or more offset section cables, such as spreader lines 26, stretch sections 36 and 44, and/or any other implementation known to those skilled in the art. In particular, the spreader lines 26 may be connected between a forward end of each outermost streamer 18 and a forward end of its adjacent streamer to assist in maintaining a substantially uniform spacing between the streamers 18. Further, the stretch sections 36 and 44 may be connected to the forward ends and rearward ends, respectively, of the streamers 18. Such stretch sections may be used for coupling to buoys, floats, and/or the like.

Marine-based seismic data acquisition system 10 may also include one or more seismic sources 16, such as air guns and the like. In one implementation, seismic sources 16 may be coupled to, or towed by, the survey vessel 11. In another implementation, seismic sources 16 may operate independently of the survey vessel 11 in that the sources 16 may be coupled to other vessels or buoys.

As seismic streamers 18 are towed behind the survey vessel 11, acoustic signals, often referred to as “shots,” may be produced by seismic sources 16 and are directed down through a water column into strata beneath a water bottom surface. Acoustic signals may be reflected from the various subterranean geological formations. The incident acoustic signals that are generated by the sources 16 produce corresponding reflected acoustic signals, or pressure waves, which may be sensed by seismic receivers 21. In one implementation, pressure waves received and sensed by seismic receivers 21 may include “up going” pressure waves that propagate to the receivers 21 without reflection, as well as “down going” pressure waves that are produced by reflections of the pressure waves from air-water boundary. Seismic receivers 21 generate signals, called “traces,” which indicate the acquired measurements of the pressure wavefield and particle motion. The traces (i.e., seismic data) may be recorded and may be processed by a signal processing unit deployed on the survey vessel 11.

The goal of the seismic acquisition is to build up an image of a survey area for purposes of identifying subterranean geological formations. Subsequent analysis of the image may reveal probable locations of hydrocarbon deposits in subterranean geological formations. In one implementation, portions of the analysis of the image may be performed on the seismic survey vessel.

Although FIG. 1 illustrates a marine-based seismic acquisition system, the marine-based seismic acquisition system is provided as an example of a seismic acquisition system that may correspond to the implementations described herein. It should be noted that the implementations described herein may also be performed on a seabed-based seismic acquisition system, a transition zone-based seismic acquisition system, and/or the like.

### Fairings

One or more fairings may be used with seismic streamers and/or seismic cables (e.g., lead-ins 20, offset section cables) deployed in a seismic acquisition system. The fairing may be attached around an outer diameter of a streamer and/or cable, and may function to improve the flow of water around the streamer and/or cable. In particular, such fairings may be used to reduce drag of the streamers and/or cables being towed or deployed through water. Such drag may lead to increased fuel costs associated with towing the streamers and/or cables, and may also lead to unwanted changes in the shape of the spread of the seismic acquisition system.

Further, such fairings may also be used to provide mechanical protection to the streamers and/or cables against cuts, wear, and abrasion. In addition, the fairings may be used to mitigate the effects of vortex shedding caused by uneven water flow around the streamers and/or cables. In particular, such mitigation may be achieved by using the fairings to improve the laminar flow of water around the streamers and/or cables. The mitigation of the effects of vortex shedding may also lead to a reduction in unwanted noise generated by such vortex shedding.

Various implementations of fairings may be used with seismic streamers and/or seismic cables. In one implementation, a hairy fairing may be used, where multiple fibers or “hairs” are used to interrupt vortex shedding and other drag inducing processes. In another implementation, a hard fairing may be used, where protrusions extending outwardly from an outer surface of the streamers and/or cables may be used to interrupt vortex shedding and other drag inducing processes.

In yet another implementation, a fabric fairing may be used, where the fabric fairing may be constructed of natural or synthetic fabric material. Such a fairing may be mounted to an outer diameter of the streamer and/or cable, such that the fabric may form a teardrop shape around the streamer and/or cable. The fabric fairing may be coupled together around the streamer and/or cable via sewing, welding, and/or any other implementation known to those skilled in the art. In such an implementation, the fabric may be composed of material such as polyester and/or any other material known to those skilled in the art. A surface treatment may also be applied to an outer surface of the fabric that may include material such as polyurethane (PU), polyvinyl chloride (PVC), and/or any other material known to those skilled in the art.

### Foul Release Material

Over time, the outer surface of a fairing used in a seismic acquisition system may be subject to fouling, particularly due to the proliferation of microorganisms (i.e., biofouling). In particular, biofouling is the accumulation of microorganisms, algae, plants, and/or the like on wetted surfaces. One such microorganism that may accumulate on the outer surface of the fairing is a barnacle.

The formation of biofouling on the outer surfaces of the fairings may impede the beneficial effects of the use of fairings cancel. In particular, an accumulation of biofouling on the fairings may lead to an increase in drag from the fairings, changes in the shape of the spread, vortex shedding, and unwanted noise recorded by seismic receivers.

Accordingly, in one implementation, the outer surfaces of the fairings may be surface treated with foul release material, where the foul release material may prevent the accumulation of biofouling from forming. In a further implementation, such foul release material may cause the outer surfaces of the fairings to become hydrophobic, thereby preventing the biofouling from attaching on the fairing. In another implementation, the foul release material may include silicone, lacquer, or any other material known to those skilled in the art.

In one implementation, the foul release material may be surface treated onto an outer surface of a fabric fairing. As noted above, the fabric fairing may be composed of material such as polyester. To perform the surface treatment, the outer surface of the fabric fairing (i.e., the polyester material) may be coated with the foul release material. For example, the outer surface of the fabric fairing may be coated with a combination of PVC and silicone or PVC and lacquer. The surface treatment may employ any methods known to those skilled in the art for applying such materials to a fabric fairing.

The fabric fairing, having its outer surface coated with the foul release material, may then be applied to a seismic streamer and/or seismic cable of a seismic acquisition system using methods known to those skilled in the art. As noted above, the fabric fairing may be coupled together around the streamer and/or cable via sewing, welding, and/or any other implementation known to those skilled in the art. In a further implementation, the fabric fairing may be applied to one or more lead-ins or one or more offset section cables of a marine seismic acquisition system, such as those described above with respect to FIG. 1.

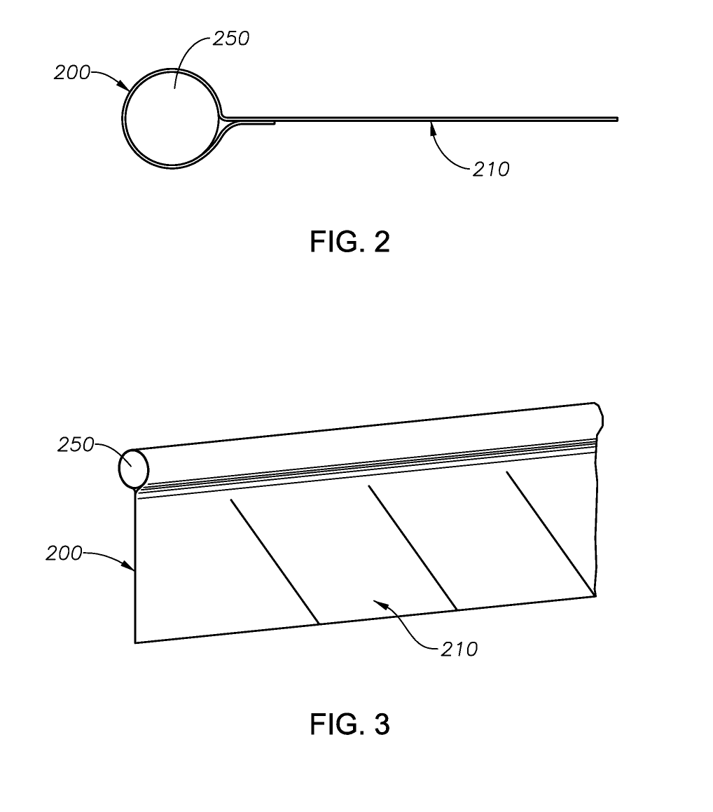

For example, FIGS. 2 and 3 illustrate a cross-sectional view and a perspective view, respectively, of a fabric fairing 200 in accordance with implementations of various techniques described herein. In particular, the fabric fairing 200 has an outer surface 210 that has been surface treated with a foul release material, where the fabric fairing 200 envelopes an outer diameter of a lead-in 250 in a marine seismic acquisition system. The fabric fairing 200 may also form a teardrop shape around the lead-in 250.

The foul release material may be applied to any fairing known to those skilled in the art. Further, the foul release material may be used with one or more seismic streamers and/or one or more seismic cables employed in any seismic acquisition system known to those skilled in the art.

In sum, by minimizing the accumulation of biofouling on the outer surfaces of the fairings, the fairings may be allowed to reduce drag of the streamers and/or cables being towed or deployed through water, prevent unwanted changes in the shape of the spread, mitigate the effects of vortex shedding, and reduce unwanted noise recorded by seismic receivers.

The foregoing description, for purpose of explanation, has been described with reference to specific implementations. However, the illustrative discussions above are not intended to be exhaustive or to limit the above-described implementations to the precise forms disclosed. Many modifications and variations are possible in view of the above teachings. The implementations were chosen and described in order to explain the principles of the above-described implementations and their practical applications, to thereby enable others skilled in the art to utilize the above-described implementations with various modifications as are suited to the particular use contemplated.

It will also be understood that, although the terms first, second, etc. may be used herein to describe various elements, these elements should not be limited by these terms. These terms are used to distinguish one element from another. For example, a first object could be termed a second object, and, similarly, a second object could be termed a first object, without departing from the scope of the claims. The first object and the second object are both objects, respectively, but they are not to be considered the same object.

The terminology used in the description of the present disclosure herein is for the purpose of describing particular implementations and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses one or more possible combinations of one or more of the associated listed items. It will be further understood that the terms “includes” and/or “including,” when used in this specification, specify the presence of stated features, integers, operations, elements, and/or components, but do not preclude the presence or addition of one or more other features, integers, operations, elements, components and/or groups thereof.

As used herein, the terms “up” and “down”; “upper” and “lower”; “upwardly” and downwardly”; “below” and “above”; and other similar terms indicating relative positions above or below a given point or element may be used in connection with some implementations of various technologies described herein. However, when applied to equipment and methods for use in wells that are deviated or horizontal, or when applied to equipment and methods that when arranged in a well are in a deviated or horizontal orientation, such terms may refer to a left to right, right to left, or other relationships as appropriate.

It should also be noted that in the development of any such actual implementation, numerous decisions specific to circumstance may be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The terminology and phraseology used herein is solely used for descriptive purposes and should not be construed as limiting in scope. Language such as “having,” “containing,” or “involving,” and variations thereof, is intended to be broad and encompass the subject matter listed thereafter, equivalents, and additional subject matter not recited.

Furthermore, the description and examples are presented solely for the purpose of illustrating the different embodiments, and should not be construed as a limitation to the scope and applicability. While any composition or structure may be described herein as having certain materials, it should be understood that the composition could optionally include two or more different materials. In addition, the composition or structure may also include some components other than the ones already cited. It should also be understood that throughout this specification, when a range is described as being useful, or suitable, or the like, it is intended that any value within the range, including the end points, is to be considered as having been stated. Furthermore, respective numerical values should be read once as modified by the term “about” (unless already expressly so modified) and then read again as not to be so modified unless otherwise stated in context. For example, “a range of from 1 to 10” is to be read as indicating a respective possible number along the continuum between about 1 and about 10. In other words, when a certain range is expressed, even if a few specific data points are explicitly identified or referred to within the range, or even when no data points are referred to within the range, it is to be understood that the inventors appreciate and understand that any data points within the range are to be considered to have been specified, and that the inventors have possession of the entire range and points within the range.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

What is claimed is:

1. A seismic cable for use in a seismic acquisition system, comprising:
a fairing configured to engage with an outer diameter of the seismic cable; and
a foul release material applied to an outer surface of the fairing, wherein the foul release material is configured to minimize the formation of biofouling on the outer surface of the fairing.

2. The seismic cable of claim 1, wherein the foul release material comprises silicone or lacquer.

3. The seismic cable of claim 1, wherein the foul release material is coated onto the fairing.

4. The seismic cable of claim 1, wherein the fairing comprises a synthetic fabric configured to engage the outer surface of the seismic cable.

5. The seismic cable of claim 4, wherein the synthetic fabric comprises a polyester material.

6. The seismic cable of claim 1, wherein the seismic cable comprises a lead-in cable coupled to one or more marine seismic streamers.

7. The seismic cable of claim 1, wherein the seismic cable comprises an offset section cable coupled to a rearward end of a marine seismic streamer.

8. The seismic cable of claim 1, wherein the outer surface of the fairing becomes hydrophobic upon application of the foul release material.

9. A seismic acquisition system, comprising:
a vessel; and
one or more seismic cables coupled to one or more seismic streamers, wherein the seismic cables are configured to be towed by the vessel, wherein a respective seismic cable comprises:
a fairing configured to engage with an outer diameter of the respective seismic cable; and
a foul release material applied to an outer surface of the fairing, wherein the foul release material is configured to minimize the formation of biofouling on the outer surface of the fairing.

10. The seismic acquisition system of claim 9, wherein the foul release material comprises silicone or lacquer.

11. The seismic acquisition system of claim 9, wherein the foul release material is coated onto the fairing.

12. The seismic acquisition system of claim 9, wherein the fairing comprises a synthetic fabric configured to engage the outer surface of the seismic cable.

13. The seismic acquisition system of claim 12, wherein the synthetic fabric comprises a polyester material.

14. The seismic acquisition system of claim 9, wherein the seismic cables comprise a lead-in cable coupled to at least one of the seismic streamers.

15. The seismic acquisition system of claim 9, wherein the seismic cables comprise an offset section cable coupled to a rearward end of one of the seismic streamers.

16. The seismic acquisition system of claim 9, wherein the outer surface of the fairing becomes hydrophobic upon application of the foul release material.

17. A method, comprising:
applying a foul release material to an outer surface of a fairing, wherein the foul release material is configured to minimize the formation of biofouling on the outer surface of the fairing; and
attaching the fairing to an outer diameter of a seismic cable for use in a seismic acquisition system.

18. The method of claim 17, wherein the foul release material comprises silicone or lacquer.

19. The method of claim 17, wherein the seismic cable comprises a lead-in cable configured to couple to one or more marine seismic streamers.

20. The method of claim 17, wherein the outer surface of the fairing becomes hydrophobic upon application of the foul release material.
